(19) United States
(12) Patent Application Publication
(10) Pub. No.: US 2015/0102994 A1
(43) Pub. Date: Apr. 16, 2015

(54) SYSTEM AND METHOD FOR MULTI-TOUCH GESTURE DETECTION USING ULTRASOUND BEAMFORMING

(71) Applicant: QUALCOMM Incorporated, San Diego, CA (US)

(72) Inventor: Hualiang NI, Markham (CA)

(73) Assignee: QUALCOMM Incorporated, San Diego, CA (US)

(21) Appl. No.: 14/051,195

(22) Filed: Oct. 10, 2013

(51) Int. Cl. G06F 3/01; G06F 3/03

(52) U.S. Cl. CPC G06F 3/017; G06F 3/0304
USPC 345/156

(57) ABSTRACT

Methods, systems, computer-readable media, and apparatuses for gesture detection using ultrasound beamforming are presented. In some embodiments, a method for gesture detection utilizing ultrasound beamforming includes projecting an ultrasound wave parallel to a surface, wherein the ultrasound wave is projected utilizing ultrasound beamforming. The method further includes receiving an ultrasound echo from an object in contact with the surface. The method additionally includes interpreting a gesture based at least in part on the received ultrasound echo.

### BACKGROUND

Aspects of the disclosure relate to gesture detection. More specifically, aspects of the disclosure relate to multi-touch gesture detection using ultrasound beamforming.

Modern touch screen devices allow for user control using simple or multi-touch gestures by touching the screen with one or more fingers. Some touchscreen devices may also detect objects such as a stylus or ordinary or specially coated gloves. The touchscreen enables the user to interact directly with what is displayed. Recently, display devices that may include touch-screen features have become larger in size. For example, the average television size is quickly approaching 40 diagonal inches. The cost of including touch-screen functionality in these larger displays is cost prohibitive. Additionally, the large size of the touch-screens requires increased extremity movement by the user, resulting in a diminished user experience. Current solutions exist in the form of traditional touch-screens, infrared (IR) led based touch frames, and dual IR camera touch solutions. However, all of these solutions require a dedicated product for different touch sizes.

Accordingly, a need exists for cost-effective and user friendly method for controlling larger display devices using simple or multi-touch gestures.

### BRIEF SUMMARY

Certain embodiments describe a portable device capable of outputting ultrasound via beamforming along a surface for multi-touch gesture recognition.

In some embodiments, a method for gesture detection includes projecting an ultrasound wave parallel to a surface, wherein the ultrasound wave is projected utilizing ultrasound beamforming. The method further includes receiving an ultrasound echo from an object in contact with the surface. The method also includes interpreting a gesture based at least in part on the received ultrasound echo.

In some embodiments, the method further includes converting the interpreted gesture into a digital image, wherein the digital image is a representation of the interpreted gesture.

In some embodiments, the method further includes executing an instruction based at least in part on the interpreting step.

In some embodiments, the object includes a user extremity.

In some embodiments, the projecting further includes creating a 2-D gesture scanning area on the surface.

In some embodiments, the 2-D gesture scanning area is defined based at least in part on a frequency or strength of the projected ultrasound wave.

In some embodiments, the projecting further comprises projecting the ultrasound wave parallel to the surface at a distance of 5 mm or less.

In some embodiments, an apparatus for gesture detection includes an ultrasound transducer array configured to project an ultrasound wave parallel to a surface, wherein the ultrasound wave is projected utilizing ultrasound beamforming. The ultrasound transducers are also configured to receive an ultrasound echo from an object in contact with the surface. The apparatus also includes a processor coupled to the ultrasound transducer configured to interpret a gesture based at least in part on the received ultrasound echo.

In some embodiments, an apparatus for gesture detection includes means for projecting an ultrasound wave parallel to a surface, wherein the ultrasound wave is projected utilizing ultrasound beamforming. The apparatus further includes means for receiving an ultrasound echo from an object in contact with the surface. The apparatus also includes means for interpreting a gesture based at least in part on the received ultrasound echo.

In some embodiments, a processor-readable medium includes processor readable instructions configured to cause a processor to project an ultrasound wave parallel to a surface, wherein the ultrasound wave is projected utilizing ultrasound beamforming. The processor readable instructions are further configured to cause the processor to receive an ultrasound echo from an object in contact with the surface. The processor readable instructions are also configured to cause the processor to interpret a gesture based at least in part on the received ultrasound echo.

### BRIEF DESCRIPTION OF THE DRAWINGS

Aspects of the disclosure are illustrated by way of example. In the accompanying figures, like reference numbers indicate similar elements, and:

FIG. 1 illustrates a simplified block diagram of an ultrasound beamforming device that may incorporate one or more embodiments;

FIG. 2A illustrates a gesture environment including an external system coupled to an ultrasound beamforming device, in accordance with some embodiments;

FIG. 2B illustrates performing a multi-touch gesture in a gesture environment, in accordance with some embodiments;

FIG. 3 illustrates one embodiment of the ultrasound beamforming device, in accordance with some embodiments;

FIG. 4 illustrates projection of ultrasound waves along a whiteboard, in accordance with some embodiments;

FIG. 5 is an illustrative flow chart depicting an exemplary operation for multi-touch gesture detection using ultrasound beamforming; and

FIG. 6 illustrates an example of a computing system in which one or more embodiments may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

In accordance with present embodiments, a small, portable, and scalable device capable of ultrasound beamforming may project an ultrasound beam parallel to a surface. In effect, this functionality may virtually convert a flat surface (e.g. tabletop, etc.) to a multi-touch surface capable of functioning as a user input device. The size of the multi-touch surface may be adjustable based on the needs of the application. The ultrasound beamforming technique used by the device may be similar to ultrasound B-mode equipment often used in medical applications (e.g., sonograms). The device may include an ultrasound transducer array operable to transmit and receive ultrasound waves, analog-to-digital converter (ADC) channels to digitize received ultrasound signals, a beamer to control transmission timing of the ultrasound beams, and a beamformer to reconstruct received ultrasound beams.

In some embodiments, the device may be as small as a typical match box. In other embodiments, the device may be built into a mobile device, e.g. a smartphone. As such, the minimal size and weight of the device offers advantages over current solutions. The device may project an ultrasound beam onto a surface and detect differences in the projected beam to determine whether a user has initiated a touch with the surface. The user may touch the surface using any user extremity. The projected beam may vary in size depending on the application and the size of the beam may further be fine-tuned based on the wave frequency and strength of the projected ultrasound beam. Further, the beam may be of a lower resolution than those used in medical applications, allowing for lower cost applications and/or faster processing time.

A method and apparatus for multi-touch gesture detection using ultrasound beamforming are disclosed. In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components of circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of myriad physical or logical mechanisms for communication between components. The present embodiments are not to be construed as limited to specific examples described herein but rather to include within their scopes all embodiments defined by the appended claims.

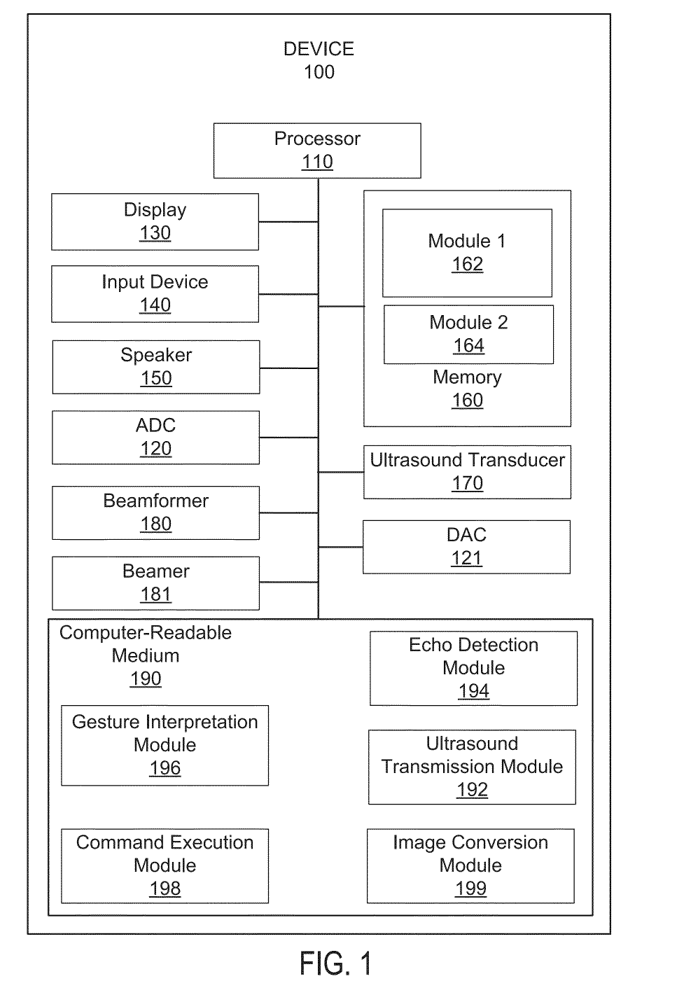

FIG. 1 illustrates a simplified block diagram of an ultrasound beamforming device 100 that may incorporate one or more embodiments. Ultrasound beamforming device 100 includes a processor 110, display 130, input device 140, speaker 150, memory 160, ADC 120, DAC 121, beamformer 180, beamer 181, ultrasound transducer 170, and computer-readable medium 190.

Processor 110 may be any general-purpose processor operable to carry out instructions on the ultrasound beamforming device 100. The processor 110 is coupled to other units of the ultrasound beamforming device 100 including display 130, input device 140, speaker 150, memory 160, ADC 120, DAC 121, beamformer 180, beamer 181, ultrasound transducer 170, and computer-readable medium 190.

Display 130 may be any device that displays information to a user. Examples may include an LCD screen, CRT monitor, or seven-segment display.

Input device 140 may be any device that accepts input from a user. Examples may include a keyboard, keypad, mouse, or touch input.

Speaker 150 may be any device that outputs sound to a user. Examples may include a built-in speaker or any other device that produces sound in response to an electrical audio signal.

Memory 160 may be any magnetic, electronic, or optical memory. Memory 160 includes two memory modules, module 1 162 and module 2 164. It can be appreciated that memory 160 may include any number of memory modules. An example of memory 160 may be dynamic random access memory (DRAM).

Computer-readable medium 190 may be any magnetic, electronic, optical, or other computer-readable storage medium. Computer-readable storage medium 190 includes ultrasound transmission module 192, echo detection module 194, gesture interpretation module 196, command execution module 198, and image conversion module 199.

DAC 121 is configured to convert a digital number representing amplitude to a continuous physical quantity. More specifically, in the present example, DAC 121 is configured to convert digital representations of ultrasound signals to an analog quantity prior to transmission of the ultrasound signals. DAC 121 may perform conversion of a digital quantity, prior to transmission by the ultrasound transducers 170 (described below).

Ultrasound transducer 170 is configured to convert voltage into ultrasound, or sound waves about the normal range of human hearing. Ultrasound transducer 170 may also convert ultrasound to voltage. The ultrasound transducer 170 may include a plurality of transducers that include piezoelectric crystals having the property of changing size when a voltage is applied, thus applying an alternating current across them causing them to oscillate at very high frequencies, thus producing very high frequency sound waves. The ultrasound transducers 170 may be arranged in an array. The array may be arranged in such a way that ultrasound waves transmitted therefrom experience constructive interference at particular angles while others experience destructive interference.

Ultrasound transmission module 192 is configured to regulate ultrasound transmissions on the device 100. The ultrasound transmission module 192 may interface with the ultrasound transducers 170 and place the ultrasound transmission module 192 in a transmit mode or a receive mode. In the transmit mode, the ultrasound transducers 170 may transmit ultrasound waves. In the receive mode, the ultrasound transducers 170 may receive ultrasound echoes. The ultrasound transmission module 192 may change the ultrasound transducer 170 between the receive and transmit modes on the fly. The ultrasound transducer 170 may also pass feedback voltages from ultrasound echoes to an ADC (described below).

Beamer 181 is configured to directionally transmit ultrasound waves. In some embodiments, the beamer 180 may be coupled to the array of ultrasound transducers 170. The beamer may also be communicatively coupled the ultrasound transmission module 192. The beamer 181 may generate control timings of the ultrasound transducers 170. That is, each of the ultrasound transducers' 170 trigger timing may be controlled by the beamer 181. The beamer may also control the transmission strength of the output from each ultrasound transducer 170. Based on the timing of each ultrasound transducer 170, the ultrasound wave transmitted may form a sound “beam” having a controlled direction. To change the directionality of the array of ultrasound transducers 170 when transmitting, the beamer 181 controls the phase and relative amplitude of the signal at each transducer 170, in order to create a pattern of constructive and destructive interference in the wavefront. Beamer 181 may transmit the waves, via ultrasound transducers 170, along or parallel to a surface (e.g., tabletop) and may contain logic for surface detection. The Beamer 181 may also include capability to modify the ultrasound waves. For example, if the wavelength or strength of the ultrasound waves needs to be modified, the beamer 181 may include logic to control the ultrasound transducers 170.

ADC 120 is configured to convert a continuous physical quantity to a digital number that represents the quantity's amplitude. More specifically, in the present example, the ADC 120 is configured to convert received ultrasound echoes into a digital representation. The digital representation may then be used for the gesture recognition techniques described herein.

The beamformer 180 is configured to process received ultrasound echoes from ultrasound waves reflected off of an object. The beamformer may analyze the ultrasound echoes, after conversion to a digital representation by the ADC 120. Here, information from the different transducers in the array is combined in a way where the expected pattern of ultrasound echoes is preferentially observed. The beamformer 180 may reconstruct the digital representation of the ultrasound echoes to a strength/frequency 1-D array. A combination of multiple 1-D arrays may be used to generate a 2D-array to be processed by the device 100.

Echo detection module 194 is configured to detect an ultrasound echo. The ultrasound echo may be generated by reflection off an object that comes into the beam of the ultrasound waves generated by the ultrasound transmission module 192. The object may be a user extremity such as a finger or an arm. The echo detection module 194 may interface with the ADC 120 to convert the received ultrasound wave echoes into a digital representation, as described above. Echo detection module 194 may also filter out irrelevant received ultrasound echoes.

The gesture interpretation module 196 is configured to interpret a gesture from the received ultrasound echo detected by the echo detection module 194. Based on the ultrasound echoes that the echo detection modules 194 receives, and in turn the ADC 120 converts the ultrasound echoes to a digital representation, the gesture interpretation module 196 may reproduce a gesture performed by the user. For example, if a user performs a “swipe” gesture with their index finger, the gesture interpretation module 196 may reproduce and interpret the swipe based on the digital representation of the ultrasound echoes.

The command execution module 198 is configured to execute a command on a system based on the gesture interpreted by gesture interpretation module 196. In some embodiments, the device 100 may be coupled to an external system for purposes of translating user input (accomplished by performing gestures) on the surface to execute a command on an external system. The external system may be, for example, a television set, gaming console, computer system, or any other system capable of receiving user input. In one non-limiting example, a user may perform a “swipe” over the virtual gesture surface created by the ultrasound beamforming device 100. Once the “swipe” gesture is recognized and interpreted by the gesture interpretation module, the command execution module 198 may translate the recognized and interpreted swipe into a native command for the external system. For example, if a user were to “swipe” from left to right, the command execution module 198 may translate the gesture into a next page command for web-browser application within a computing system. In some embodiments, the command execution module 198 may interface with a database (not shown) to retrieve an available list of commands native to the external system.

Image conversion module 199 is configured to convert a series of gestures into a digital file format. The digital file format may be, for example, Portable Document Format (PDF), JPEG, PNG, etc. The memory 160 within ultrasound beamforming device 100 may be used to store the series of gestures prior to conversion into the digital file format.

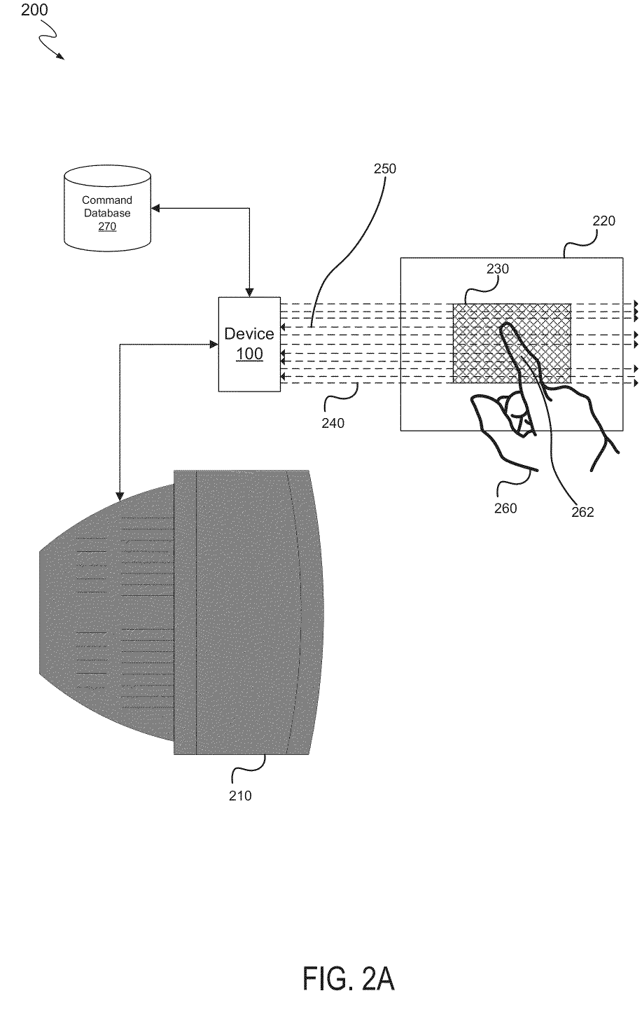

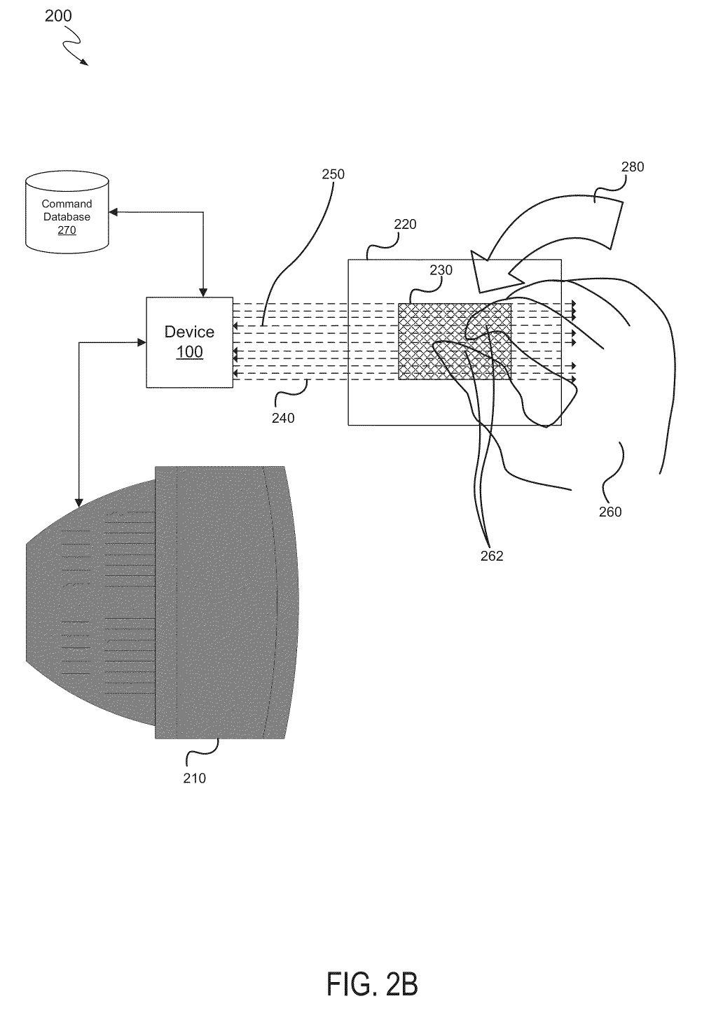

FIG. 2A illustrates a gesture environment 200 including an external system 210 coupled to an ultrasound beamforming device 100. In this particular example, the external system 210 is a television or other display device. The ultrasound beamforming device 100 may be coupled to external system 210 by either a wired or wireless connection. Some examples of wired connections include, but are not limited to, Universal Serial Bus (USB), FireWire, Thunderbolt, etc. Some examples of wireless connections include, but not are not limited to, Wi-Fi, Bluetooth, RF, etc. FIG. 2A also includes a surface 220. Surface 220 may be any flat surface including, but not limited to, a tabletop, countertop, floor, wall, etc. Surface 220 may also include surfaces of movable objects such as magazines, notepads, or any other movable object having a flat surface.

As described above, ultrasound beamforming device 100 is configured to project ultrasound waves 240 and receive ultrasound echoes 250. The ultrasound echoes 250 may be reflected off an object, such as a user extremity. In this example, the user extremity is a user's hand 260. Specifically, the ultrasound echoes 250 reflect off of the index finger 262 of the user's hand 260. The ultrasound echoes 250 may be detected by the ultrasound beamforming device 100 using the echo detection module 194, as described above.

The ultrasound beamforming device 100 may be configured to create a virtual gesture surface 230 by projecting the ultrasound waves 240 along or parallel to the surface 220. The virtual gesture surface 230 may be formed on the entire surface 220 or within a specific area of the surface 220 depending on the manner in which the ultrasound waves are projected. In some embodiments, the ultrasound beamforming device 100 may project the ultrasound waves 240 using beamforming techniques. Such a technique may allow the ultrasound beamforming device 100 to control the direction of the ultrasound waves 240 projected toward the surface 220. In some embodiments, the ultrasound beamforming device 100 may include logic to automatically detect a surface 220 and project the ultrasound waves 240 towards the surface without any manual calibration. The ultrasound beamforming device 100 may project the ultrasound waves using ultrasound transmission module 192, ultrasound transducer 170, and beamer 181, as described above. In some embodiments, the difference in distance between the projected ultrasound waves 240 and the surface 220 may be 5 mm or less.

As described above, the ultrasound beamforming device 100 may recognize and interpret a gesture performed by a user extremity. For example, the ultrasound beamforming device 100 may recognize and interpret a gesture performed by the finger 262 of the user's hand 260. The recognizing and interpreting may be accomplished using the gesture interpretation module 196, as described above. The gesture interpretation module 196 may determine differences in time between when an ultrasound wave 240 was projected along the surface 220 and when an ultrasound echo 250 was received by the ultrasound beamforming device 100. From the determined difference in time, the distance of the user's finger 262 from the ultrasound beamforming 100 device may be determined. Additionally, the angle and direction of the ultrasound echo 250 may also be determined by the gesture interpretation module 196.

In some embodiments, the ultrasound waves 240 are short-timed pulses travelling away from the ultrasound transducers 170 along the beam direction. When the ultrasound waves 240 come into contact with an object, ultrasound echoes will bounce back and travel towards the ultrasound transducers 170. Some of the energy from the ultrasound waves 240 pass through the object and continue on their path. When those ultrasound waves 240 come into contact with another object, more ultrasound echoes will bounce back and travel towards the ultrasound transducers 170. Accordingly, by measuring the time between the transmission of the ultrasound waves and the received ultrasound echo of the ultrasound echoes, the distance from the device 100 to the object may be calculated. More ultrasound waves 240 may be transmitted in another direction (typically a few degrees from the last transmission) and further ultrasound echoes are received from these ultrasound waves 240. In some embodiments, hundreds of ultrasound waves may be transmitted and hundreds of ultrasound echoes may be received, which may eventually form a 2-D scanning area. In some embodiments, multiple ultrasound waves 240 may be transmitted in different directions simultaneously to speed up the scanning rate.

Once the gesture is recognized and interpreted by the gesture interpretation module 196, the ultrasound beamforming device 100 may relay a command for execution to the external system 210. The command may be based on the recognized and interpreted gesture. For example, if the recognized gesture is the finger 262 swiping in a left-to-right motion on the virtual gesture surface 230, the command may be for the external system 210 to flip to a next page within a user interface. In some embodiments, the gesture environment 200 may include a command database 270. The command database 270 may store a plurality of command mappings that map a gesture to a command native to the external system 210. Upon recognizing and interpreting a gesture, the ultrasound beamforming device 100 may query the command database 270 with the recognized and interpreted gesture in order to determine a command native to the external system 210 that is represented by the gesture. In some embodiments, the native command may be relayed from the ultrasound beamforming device 100 to the external system 210 using one of the above mentioned wired or wireless connections.

It can be appreciated that while one finger 262 is shown performing a gesture on the virtual gesture surface 230, any number of fingers or other user extremities may be used to perform a gesture on the virtual gesture surface 230. This multi-touch functionality may be operable to execute a wide array of commands on the external system 210.

FIG. 2B illustrates performing a multi-touch gesture in a gesture environment 200. The gesture environment includes an external system 210 coupled to an ultrasound beamforming device 100. FIG. 2B is similar to FIG. 2A except that the user's hand 260 is performing a multi-touch “pinching” gesture with his/her fingers 262. The pinching gesture may involve the user bringing his/her two fingers 262 together on the virtual gesture surface 230. The pinching gesture may represent a user command for zooming of content on the external system 210.

At a first time, the device 100 may project a series of ultrasound waves 240 toward the user's fingers 262. As the user performs the pinching motion 280 with his/her fingers, the device 100 may continue to project more ultrasound waves 240 while simultaneously receiving ultrasound echoes 250 reflected off the user's fingers 262. From analyzing the received ultrasound echoes 250, as described above, the device may recognize the entire pinching motion 280 from the user's fingers 262.

Once the gesture is recognized and interpreted by the gesture interpretation module 196, the ultrasound beamforming device 100 may relay a command for execution to the external system 210. The command may be based on the recognized and interpreted gesture from the pinching motion 280.

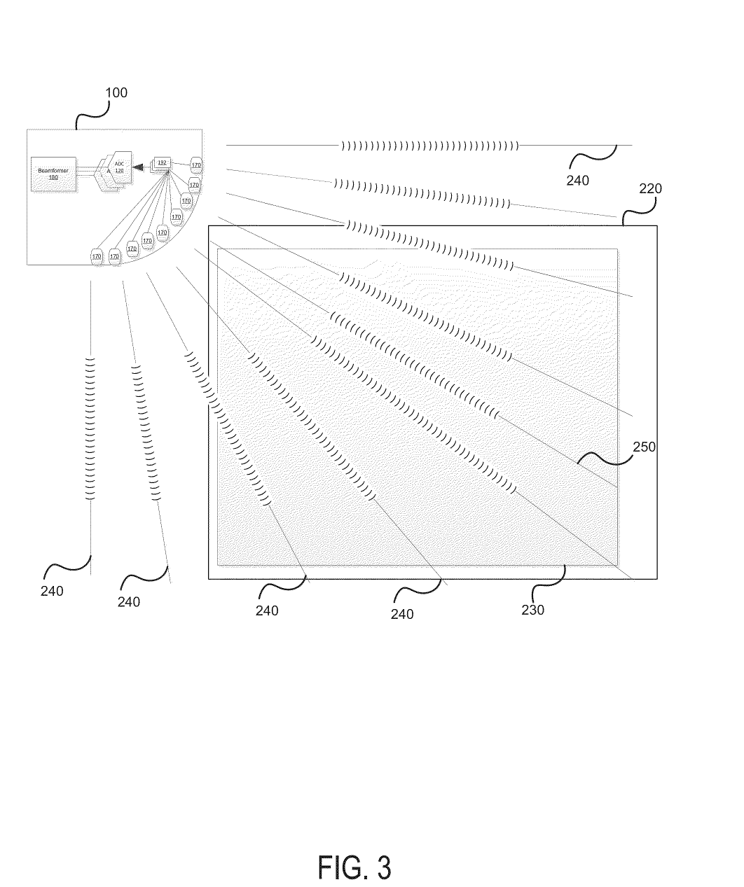

FIG. 3 illustrates one embodiment of the ultrasound beamforming device 100, in accordance with some embodiments. As described with reference to FIG. 1, the ultrasound beamforming device 100 includes a beamformer 180, beamer 181, one or more analog-to-digital converters 120, an ultrasound transmission module 192, and one or more ultrasound transducers 170.

The ultrasound beamforming device is configured to send ultrasound waves 240 and receive ultrasound echoes 250. The ultrasound echoes 250 may be a reflection of an ultrasound wave off an object. In some embodiments, the object may be a user extremity. The plurality of ultrasound waves 240 are projected by the ultrasound transducers 170 of the ultrasound beamforming device 100. The arrangement of the ultrasound transducers 170 may determine in part the angle, frequency, and strength of the ultrasound waves 240. In some embodiments, the ultrasound waves 240 are projected along a surface 220.

The plurality of ultrasound waves 240 may form a “virtual” gesture surface 230 over the surface 220 wherein a user may perform gestures using, for example, a user extremity. In some embodiments, the ultrasound waves 240 may be at a distance of 5 mm or less from the surface.

As described above, ultrasound transmission module 192 is configured to transmit ultrasound waves via the ultrasound transducer arrays 170. The ultrasound transducer arrays 170 may also receive ultrasound echoes 250. The ultrasound transmission module 192 may also be coupled to the one or more ADCs 120, which in turn are coupled to beamformer 180. The one or more ADCs 120 may take a received ultrasound echo 250 and convert an analog signal representation of the received echo 250 to a digital representation. The ADCs may be coupled to beamformer 180 wherein the beamformer 180 may be configured to receive the digital representation of the received ultrasound echo 250 from the one or more ADCs 120. When receiving, information from the different transducers 170 in the array is combined in a way where the expected pattern of ultrasound waves is preferentially observed.

The ultrasound waves may be transmitted using the beamer 181 as described above. The ultrasound transmission module 192 may transmit the waves along a surface (e.g., tabletop) and may contain logic for surface detection. The beamer 181 may also include capability to modify the ultrasound waves transmitted via the ultrasound transducers 170. For example, if the wavelength or strength of the ultrasound waves needs to be modified, the beamer 181 may include logic to control the behavior of the ultrasound transducers 170.

In some embodiments, the ultrasound waves 240 may be projected along the surface 220 such that the virtual gesture surface 230 is created by a “sweeping scan” of the ultrasound waves 240. That is, each ultrasound transducer 170 may project an ultrasound wave 240 in a one-by-one sequence. In other words, the array of ultrasound transducers 170 is configured with a certain timing to trigger each ultrasound transducer 170 and to project an ultrasound wave (beam) with a controlled direction. As mentioned above, the beamer 181 may control the timing of the ultrasound transducers 170. As such, the ultrasound waves 240 may effectively scan across the surface 220 to detect a gesture input by a user.

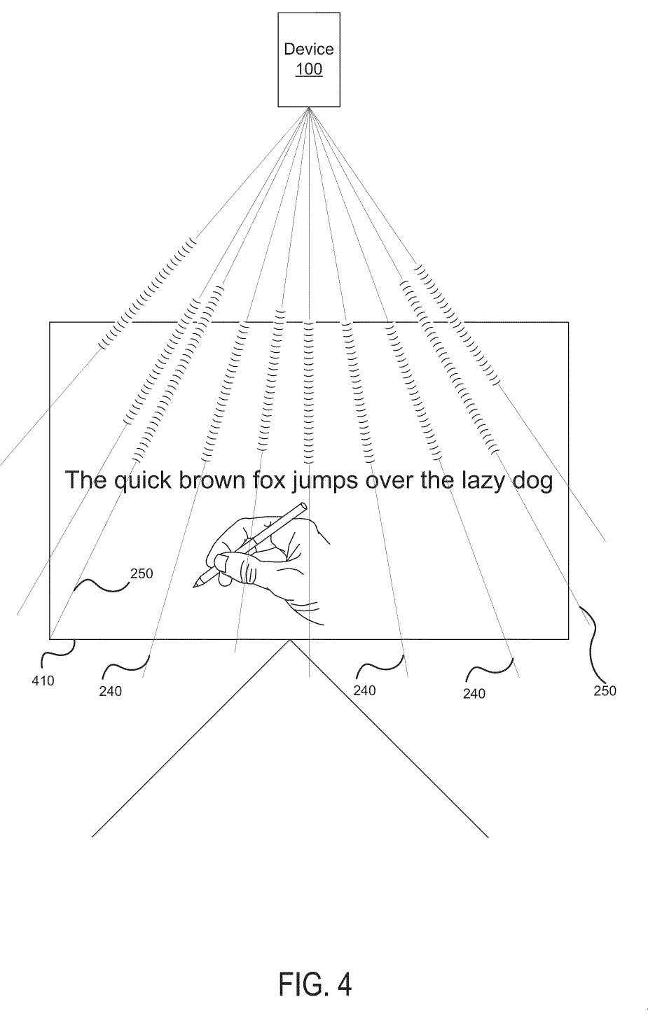

FIG. 4 illustrates projection of ultrasound waves 240 along a whiteboard 410, in accordance with some embodiments. As described above, image conversion module 199 is configured to convert a series of gestures into a digital file format. The digital file format may be, for example, Portable Document Format (PDF), JPEG, PNG, etc. The memory 160 within ultrasound beamforming device 100 may be used to store the series of gestures prior to conversion into the digital file format.

The ultrasound beamforming device 100 may project a number of ultrasound waves 240 along the whiteboard 410. In some embodiments, the ultrasound beamforming device 100 may be positioned above the whiteboard 410 such that the ultrasound waves 240 may be projected downward along the surface of the whiteboard 410. However, it can be appreciated that the ultrasound beamforming device 100 may be placed in any position relative to the whiteboard 410.

The ultrasound waves 240 may reflect off of an object along the whiteboard 410 and reflect ultrasound echoes 250 back toward the ultrasound beamforming device 100. In some embodiments, the object may be a user extremity holding a writing instrument. The user may draw characters on the whiteboard 410 with the writing instrument and the ultrasound echoes 250 (that are a reflection off the user extremity or writing instrument) that return to the ultrasound beamforming device 100 may indicate, using the methods described above, hand motions or writing instrument motions performed by the user. When the user lifts the writing instrument off the whiteboard 410, the ultrasound waves 240 will not be blocked by any object indicating that the user is not in the process of drawing any characters on the whiteboard 410. In some embodiments, the ultrasound beamforming device 100 may store the series of determined user motions into memory 160 local to the ultrasound beamforming device 100.

The stored series of determined user motions may be converted to a digital file format similar to the ones given as examples above. In some embodiments, the series of determined user motions may be converted to a digital file format “on-the-fly” without storing the detected user motions in memory 160.

For example, in FIG. 4, a user may draw the text “The quick brown fox jumps over the lazy dog” on the whiteboard 410 using a pen. The ultrasound beamforming device 100 may scan the surface of the whiteboard 410 with ultrasound waves 240 as described above. Any ultrasound waves 240 coming into contact with the user's hand or the pen may reflect an ultrasound echo 250 to the ultrasound beamforming device 100. The ultrasound beamforming device 100 may record the received ultrasound echoes 250 and determine the drawing strokes performed by the user on the whiteboard 410 therefrom. The ultrasound beamforming device 100 may store the determined drawing strokes, which represent “The quick brown fox jumps over the lazy dog” into memory 160. The drawing strokes may then be converted into a digital file format, such as a PDF file.

It can be appreciated that a plurality of writing instruments may also be used by the user to draw on the whiteboard 410. In some embodiments, a user may also use any other object to perform drawing motions on the whiteboard 410 without actually transferring any kind of ink to the whiteboard. For example, a user may use stylus or other object to outline a drawing on the whiteboard 410. The motion of the user's strokes may be captured by the ultrasound beamforming device 100 and converted to a digital format.

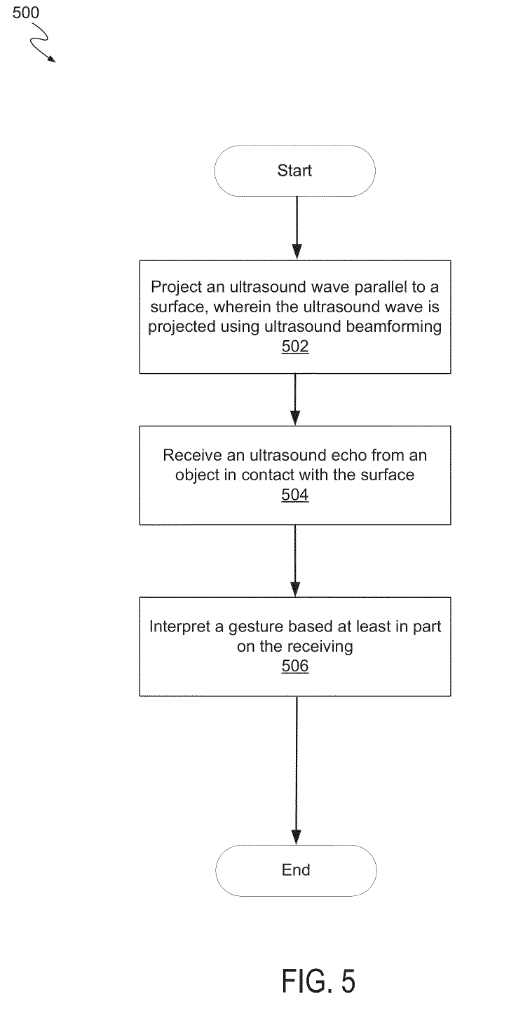

FIG. 5 is an illustrative flow chart 500 depicting an exemplary operation for multi-touch gesture detection using ultrasound beamforming. In block 502, an ultrasound wave is projected parallel to a surface, wherein the ultrasound wave is projected utilizing ultrasound beamforming. In some embodiments, the projecting further includes creating a 2-D gesture scanning area on the surface. The 2-D gesture scanning area may be defined based at least in part on a frequency of the ultrasound wave. In some embodiments, the ultrasound waves are projected at a distance of 5 mm or less along the surface.

For example, in FIG. 2A, the ultrasound beamforming device projects a plurality of ultrasound waves parallel to the surface. The projected ultrasound waves create a virtual gesture surface, e.g. 2-D gesture scanning area, on the surface. The virtual gesture surface may be used by a user to perform gesture input to an external system.

In block 504, an ultrasound echo is received from an object in contact with the surface. In some embodiments, the object may include a user extremity, for example, a hand or an arm. For example, in FIG. 2A, a user's finger on the user's hand is in contact with the virtual gesture surface. The ultrasound waves projected along the surface may come in contact with the user's finger and reflect ultrasound echoes back toward the ultrasound beamforming device.

In block 506, a gesture is interpreted based at least in part on the received ultrasound echo. The gesture may be interpreted to determine a command to relay to an external system. The command may be determined by querying a command database including a mapping of gestures to commands native to the external system. For example, in FIG. 2A, the ultrasound beamforming device may interpret a gesture performed by the user's finger based on the received ultrasound echoes. The ultrasound beamforming device may then query the command database with the interpreted gesture to determine a command associated with the gesture. The command may then be relayed to the external system for execution.

In some embodiments, the method also includes converting the interpreted gesture into a digital image, wherein the digital image is a representation of the interpreted gesture. For example, a user may perform gestures in the manner of drawing on a whiteboard. The ultrasound beamforming device may record the gesture movements based on the received ultrasound echoes and store them into memory. The recorded gesture movements in memory may then be converted into a digital file format, e.g. PDF file, representing the gesture movements.

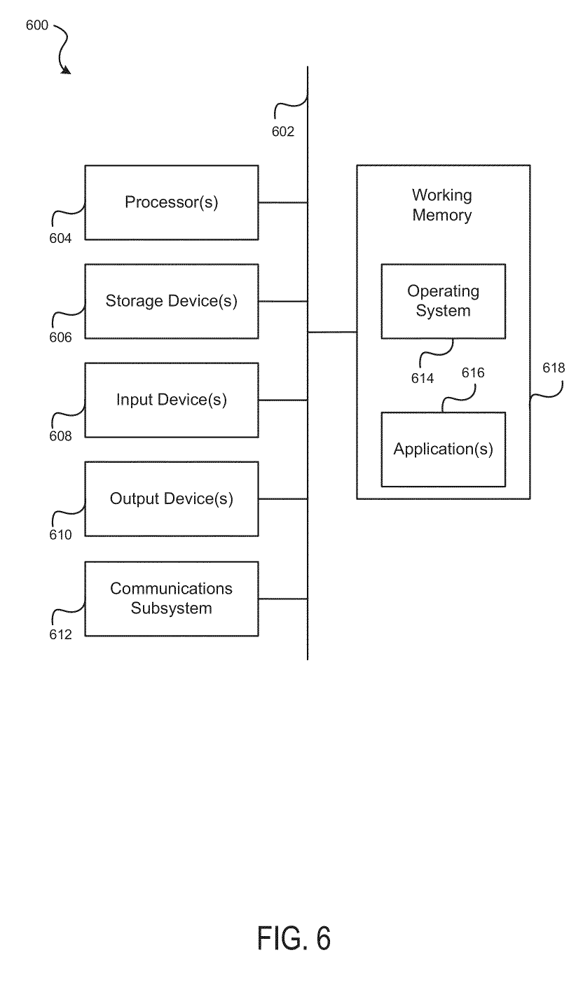

FIG. 6 illustrates an example of a computing system in which one or more embodiments may be implemented. A computer system as illustrated in FIG. 6 may be incorporated as part of the above described computerized device. For example, computer system 600 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 6 provides a schematic illustration of one embodiment of a computer system 600 that can perform the methods provided by various other embodiments, as described herein, and/or can function as the host computer system, a remote kiosk/terminal, a point-of-sale device, a telephonic or navigation or multimedia interface in an automobile, a computing device, a set-top box, a table computer and/or a computer system. FIG. 6 is meant only to provide a generalized illustration of various components, any or all of which may be utilized as appropriate. FIG. 6, therefore, broadly illustrates how individual system elements may be implemented in a relatively separated or relatively more integrated manner. In some embodiments, computer system 600 may implement functionality of external system 210 in FIG. 2A.

The computer system 600 is shown comprising hardware elements that can be electrically coupled via a bus 602 (or may otherwise be in communication, as appropriate). The hardware elements may include one or more processors 604, including without limitation one or more general-purpose processors and/or one or more special-purpose processors (such as digital signal processing chips, graphics acceleration processors, and/or the like); one or more input devices 608, which can include without limitation one or more cameras, sensors, a mouse, a keyboard, a microphone configured to detect ultrasound or other sounds, and/or the like; and one or more output devices 610, which can include without limitation a display unit such as the device used in embodiments of the invention, a printer and/or the like.

In some implementations of the embodiments of the invention, various input devices 608 and output devices 610 may be embedded into interfaces such as display devices, tables, floors, walls, and window screens. Furthermore, input devices 608 and output devices 610 coupled to the processors may form multi-dimensional tracking systems.

The computer system 600 may further include (and/or be in communication with) one or more non-transitory storage devices 606, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 600 might also include a communications subsystem 612, which can include without limitation a modem, a network card (wireless or wired), an infrared communication device, a wireless communication device and/or chipset (such as a Bluetooth™ device, an 802.11 device, a Wi-Fi device, a WiMax device, cellular communication facilities, etc.), and/or the like. The communications subsystem 612 may permit data to be exchanged with a network, other computer systems, and/or any other devices described herein. In many embodiments, the computer system 600 will further comprise a non-transitory working memory 618, which can include a RAM or ROM device, as described above.

The computer system 600 also can comprise software elements, shown as being currently located within the working memory 618, including an operating system 614, device drivers, executable libraries, and/or other code, such as one or more application programs 616, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 606 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some embodiments, one or more elements of the computer system 600 may be omitted or may be implemented separate from the illustrated system. For example, the processor 604 and/or other elements may be implemented separate from the input device 608. In one embodiment, the processor is configured to receive images from one or more cameras that are separately implemented. In some embodiments, elements in addition to those illustrated in FIG. 6 may be included in the computer system 600.

Some embodiments may employ a computer system (such as the computer system 600) to perform methods in accordance with the disclosure. For example, some or all of the procedures of the described methods may be performed by the computer system 600 in response to processor 604 executing one or more sequences of one or more instructions (which might be incorporated into the operating system 614 and/or other code, such as an application program 616) contained in the working memory 618. Such instructions may be read into the working memory 618 from another computer-readable medium, such as one or more of the storage device(s) 606. Merely by way of example, execution of the sequences of instructions contained in the working memory 618 might cause the processor(s) 604 to perform one or more procedures of the methods described herein.

The terms “machine-readable medium” and “computer-readable medium,” as used herein, refer to any medium that participates in providing data that causes a machine to operate in a specific fashion. In some embodiments implemented using the computer system 600, various computer-readable media might be involved in providing instructions/code to processor(s) 604 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 606. Volatile media include, without limitation, dynamic memory, such as the working memory 618. Transmission media include, without limitation, coaxial cables, copper wire and fiber optics, including the wires that comprise the bus 602, as well as the various components of the communications subsystem 612 (and/or the media by which the communications subsystem 612 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 604 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments of the invention.

The communications subsystem 612 (and/or components thereof) generally will receive the signals, and the bus 602 then might carry the signals (and/or the data, instructions, etc. carried by the signals) to the working memory 618, from which the processor(s) 604 retrieves and executes the instructions. The instructions received by the working memory 618 may optionally be stored on a non-transitory storage device 606 either before or after execution by the processor(s) 604.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figures. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Thus, in the description above, functions or methods that are described as being performed by the computer system may be performed by a processor—for example, the processor 604—configured to perform the functions or methods. Further, such functions or methods may be performed by a processor executing instructions stored on one or more computer readable media.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

What is claimed is:

1. A method for gesture detection, comprising:
projecting an ultrasound wave parallel to a surface, wherein the ultrasound wave is projected utilizing ultrasound beamforming;
receiving an ultrasound echo from an object in contact with the surface; and
interpreting a gesture based at least in part on the received ultrasound echo.

2. The method of claim 1 further comprising converting the interpreted gesture into a digital image, wherein the digital image is a representation of the interpreted gesture.

3. The method of claim 1 further comprising executing an instruction based at least in part on the interpreting step.

4. The method of claim 1 wherein the object comprises a user extremity.

5. The method of claim 1 wherein the projecting further comprises creating a 2-D gesture scanning area on the surface.

6. The method of claim 5 wherein the 2-D gesture scanning area is defined based at least in part on a frequency or strength of the projected ultrasound wave.

7. The method of claim 1 wherein the projecting further comprises projecting the ultrasound wave parallel to the surface at a distance of 5 mm or less.

8. An apparatus for gesture detection, comprising:
an ultrasound transducer array configured to:
project an ultrasound wave parallel to a surface, wherein the ultrasound wave is projected utilizing ultrasound beamforming;
receive an ultrasound echo from an object in contact with the surface; and
a processor coupled to the ultrasound transducer configured to interpret a gesture based at least in part on the received ultrasound echo.

9. The apparatus of claim 8 wherein the processor is further configured to convert the interpreted gesture into a digital image, wherein the digital image is a representation of the interpreted gesture.

10. The apparatus of claim 8 wherein the processor is further configured to execute an instruction based at least in part on the interpreting step.

11. The apparatus of claim 8 wherein the object comprises a user extremity.

12. The apparatus of claim 8 wherein the projecting further comprises creating a 2-D gesture scanning area on the surface.

13. The apparatus of claim 12 wherein the 2-D gesture scanning area is defined based at least in part on a frequency or strength of the projected ultrasound wave.

14. The apparatus of claim 8 wherein the projecting further comprises projecting the ultrasound wave parallel to the surface at a distance of 5 mm or less.

15. An apparatus for gesture detection, comprising:
means for projecting an ultrasound wave parallel to a surface, wherein the ultrasound wave is projected utilizing ultrasound beamforming;
means for receiving an ultrasound echo from an object in contact with the surface; and
means for interpreting a gesture based at least in part on the received ultrasound echo.

16. The apparatus of claim 15 further comprising means for converting the interpreted gesture into a digital image, wherein the digital image is a representation of the interpreted gesture.

17. The apparatus of claim 15 further comprising executing an instruction based at least in part on the interpreting step.

18. The apparatus of claim 15 wherein the object comprises a user extremity.

19. The apparatus of claim 15 wherein the projecting further comprises creating a 2-D gesture scanning area on the surface.

20. The apparatus of claim 19 wherein the 2-D gesture scanning area is defined based at least in part on a frequency or strength of the projected ultrasound wave.

21. The apparatus of claim 15 wherein the projecting further comprises projecting the ultrasound wave parallel to the surface at a distance of 5 mm or less.

22. A processor-readable non-transitory medium comprising processor readable instructions configured to cause a processor to:
project an ultrasound wave parallel to a surface, wherein the ultrasound wave is projected utilizing ultrasound beamforming;
receive an ultrasound echo from an object in contact with the surface; and
interpret a gesture based at least in part on the received ultrasound echo.

23. The processor-readable non-transitory medium of claim 22 wherein the instructions are further configured to cause the processor to convert the interpreted gesture into a digital image, wherein the digital image is a representation of the interpreted gesture.

24. The processor-readable non-transitory medium of claim 22 wherein the instructions are further configured to cause the processor to execute an instruction based at least in part on the interpreting step.

25. The processor-readable non-transitory medium of claim 22 wherein the object comprises a user extremity.

26. The processor-readable non-transitory medium of claim 22 wherein the projecting further comprises creating a 2-D gesture scanning area on the surface.

27. The processor-readable non-transitory medium of claim 26 wherein the 2-D gesture scanning area is defined based at least in part on a frequency or strength of the projected ultrasound wave.

28. The processor-readable non-transitory medium of claim 22 wherein the projecting further comprises projecting the ultrasound wave parallel to the surface at a distance of 5 mm or less.
